(19) United States
(12) Patent Application Publication
(10) Pub. No.: US 2015/0327713 A1
(43) Pub. Date: Nov. 19, 2015

(54) SINGLE SERVE BREWING SYSTEM FOR DRIP COFFEE MAKERS

(71) Applicant: JOE POD VENTURES, LLC, Atlanta, GA (US)

(72) Inventor: Joseph William Pruitt, Athens, GA (US)

(73) Assignee: JOE POD VENTURES, LLC, Atlanta, GA (US)

(21) Appl. No.: 14/276,176

(22) Filed: May 13, 2014

(51) Int. Cl. A47J 31/40; B65D 85/804

(52) U.S. Cl. CPC A47J 31/407; B65D 85/8046

(57) ABSTRACT

A single serve brewing system includes a water reservoir assembly, a pod retaining assembly and a strength adjustment assembly. The water reservoir assembly includes a concave member defining a predetermined volume, a first piercing member disposed on the concave member, a brew port formed on the concave member, and a water bypass opening formed on the concave member. The pod retaining assembly is pivotally coupled to the water reservoir assembly, and includes a housing defining an interior space, a pod support member, a second piercing member, a brewed beverage opening; and a dilution opening. The strength adjustment assembly includes a hollow tube disposed in the housing and having a first end adapted to extend through the water bypass opening and a second end coupled to the dilution opening to bypass the interior space. The strength adjustment assembly also includes a knob coupled to the hollow tube adapted to displace the hollow tube.

### TECHNICAL FIELD

The subject matter disclosed herein generally relates to brewing devices and more particularly to single serve brewing systems for drip brewing devices.

### BACKGROUND

An electric drip coffee maker normally works by flowing water from a cold water reservoir through a conduit and into a heating chamber, where a heating element heats the water. Thermally-induced pressure and a siphoning effect move the heated water through a conduit into a spray head, where the water is sprayed onto ground coffee beans using only the pressure created by gravity. The ground coffee beans are typically disposed in a filter that is contained in a brew basket mounted below the spray head. The coffee passes through the filter and drips down into a carafe.

Prepackaged containers or pods for use with brewing devices are well known, and may include one or more filters as well as a brewing material such as ground coffee beans, tea leaves, powdered chocolate, etc. The pods are inserted into a holding assembly and the pod is pierced when the holding assembly is closed. Heated water at elevated pressure is passed through the pod and the brewing material to brew a single serve of a brewed beverage. In some brewers the elevated pressure is about to psi and in the case of espresso brewers can be as high as 250 psi.

Hybrid coffee makers that use loose coffee grounds or alternately pods are known and typically include a brewing assembly designed to operate using an open filter or a pod. In the open filter mode, the water is generally dispensed onto the grounds at ambient pressure, with water flowing through the grounds generally in response to gravity. In the pod configuration, the water is generally dispensed onto the grounds at an elevated pressure (i.e., a pressure above ambient), with the water flow through the grounds being generally pressurized.

One of the disadvantages of existing drip coffee makers that are converted for use with a pod is that the resulting beverage is usually too strong. Additionally, existing drip coffee makers that are converted for use with the pod take a long time to brew compared to traditional drip brewing. Consequently there is a need for a simple system that allows the brewing of a single serve beverage from a pod using a drip brewing device that provides the user with the ability to control the strength of the resulting beverage.

### SUMMARY

The disclosure provides a solution to the problem of an unacceptable brew time and unacceptable strength of a beverage made using a pod in a drip brewing device.

In accordance with one exemplary non-limiting embodiment, the invention relates to an apparatus having (1) a water reservoir assembly, (2) a pod retaining assembly pivotally coupled to the water reservoir assembly, and (3) a strength adjustment assembly. The water reservoir assembly includes a concave member defining a predetermined volume, a first piercing member disposed on the concave member, a brew port formed on the concave member and a water bypass opening formed on the concave member. The pod retaining assembly includes a housing defining an interior space, a pod support member, a second piercing member, a brewed beverage opening, and a dilution opening. The brew strength adjustment assembly includes a hollow tube disposed in the housing and having a first end adapted to extend through the water bypass opening and a second end coupled to the dilution opening to bypass the interior space, and a knob coupled to the hollow tube adapted to displace the hollow tube.

In another embodiment, a beverage pod receptacle is provided having a concave member having a brew port and a water bypass opening, a housing pivotally coupled to the concave member and a pod support member formed on the housing. The beverage pod receptacle also includes a first piercing member disposed on the concave member and a second piercing member disposed on the housing below the pod support member. The beverage pod receptacle is provided with a tube disposed in the housing, the tube is adapted to extend through the water bypass opening. The beverage pod receptacle also includes means for displacing the tube.

In another embodiment, an apparatus for brewing a single serve of coffee into a container in a drip coffee maker is provided. The apparatus includes a reservoir for hot water from the drip coffee maker. The apparatus also includes means for holding a pod containing coffee grounds, means for piercing the top of the pod, and means for piercing the bottom of the pod. The apparatus further includes means for flowing a portion of the hot water through the pod to make brewed coffee, means for flowing a portion of the water directly into the container to adjust the strength of the brewed coffee, and means for controlling the portion of the water flowing into the container.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a perspective view of an embodiment of a single serve brewing system.

FIG. 2 is a cross section of an embodiment of a single serve brewing system.

FIG. 3 is an illustration of an embodiment of a drip brewing device.

FIG. 4 is an exploded view of a brew basket and an embodiment of the single serve brewing system.

FIG. 5 is a perspective view of an alternate embodiment of a single serve brewing system.

FIG. 6 is a cross section of an alternate embodiment of a single serve brewing system.

FIG. 7 is a detailed view of a stepped tip in accordance with an embodiment.

FIG. 8 is a side view of a stepped tip in a first position.

FIG. 9 is a side view of a stepped tip in a second position.

FIG. 10 is a side view of a stepped tip in a third position.

FIG. 11 is a perspective cross section of an embodiment of a pod adapter.

FIG. 12 is an exploded view of an embodiment of a pod adapter.

FIG. 13 is an exploded view of a pour over brewer assembly.

### DETAILED DESCRIPTION OF ILLUSTRATIVE EMBODIMENTS

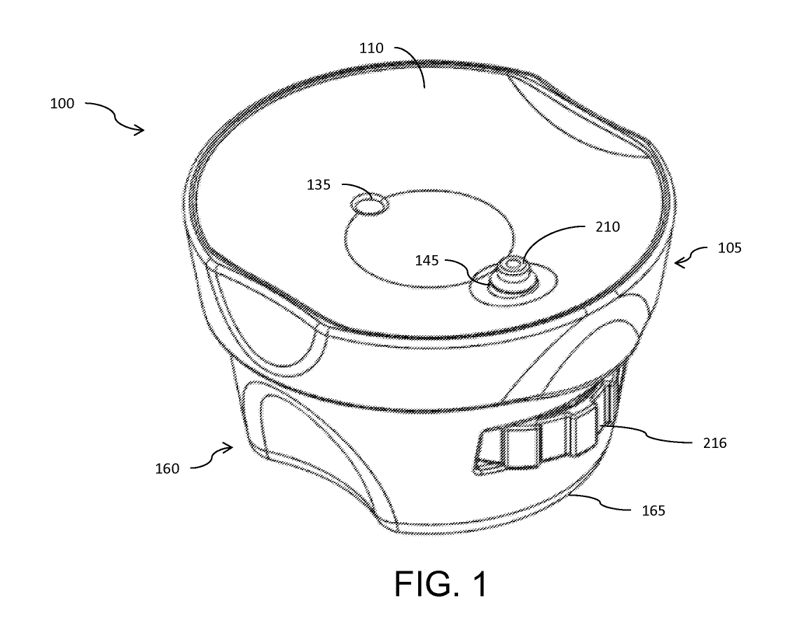

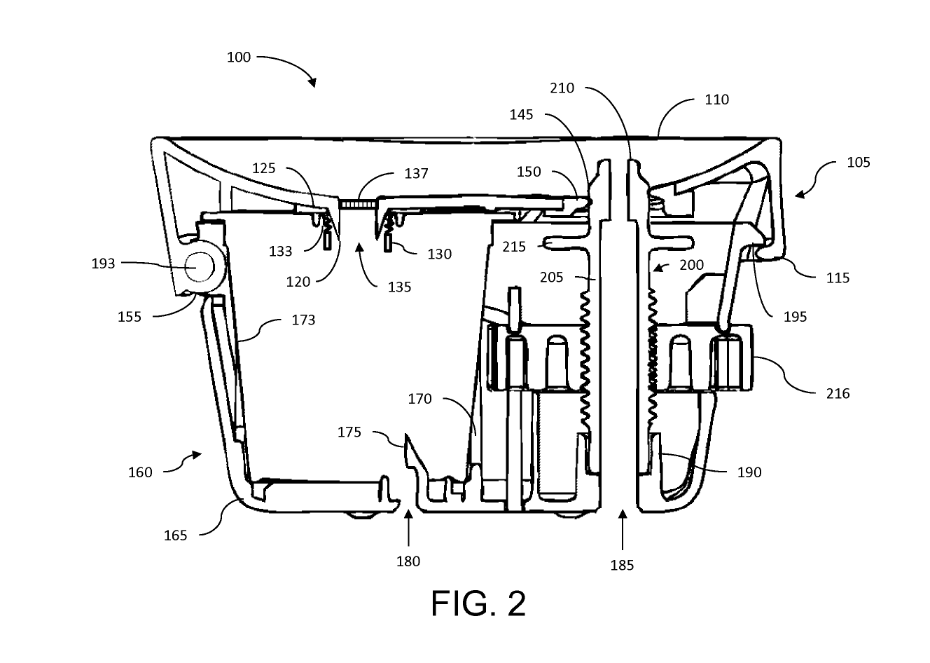

Illustrated in FIGS. 1 and 2 is an embodiment of a single serve brewing system 100. The single serve brewing system 100 includes a water reservoir assembly 105. The water reservoir assembly 105 includes a concave member 110 which may be made of heat resistant plastic with an inwardly projecting locking protrusion 115 and a first piercing member 120. The concave member 110 defines a predetermined volume which will be of sufficient size to permit the brew of at least one cup of brewed beverage. The first piercing member 120 may be a metal or plastic piece attached to the concave member 110, or may be integrally formed on the concave member 110. The first piercing member 120 may be provided with a seal 125. In one embodiment, the water reservoir assembly 105 may be provided with a guard 130 which may be biased with a spring 133 or other biasing means as a safety feature to prevent injuries from the first piercing member 120. The water reservoir assembly 105 may also include a brew port 135 that is an opening on the water reservoir assembly 105 that allows water to drip through the first piercing member 120. The first piercing member 120 is hollow and has an opening aligned with the brew port 135. The brew port 135 may be provided with a screen 137 to prevent the material being brewed (e.g. coffee grounds) from rising into the concave member 110 during the brewing process. The water reservoir assembly 105 may be provided with a water bypass opening 145 and a bypass seal 150. A hinge cylinder 155 may be attached to the water reservoir assembly 105 or alternately the hinge cylinder 155 may be integrally formed with the concave member 110.

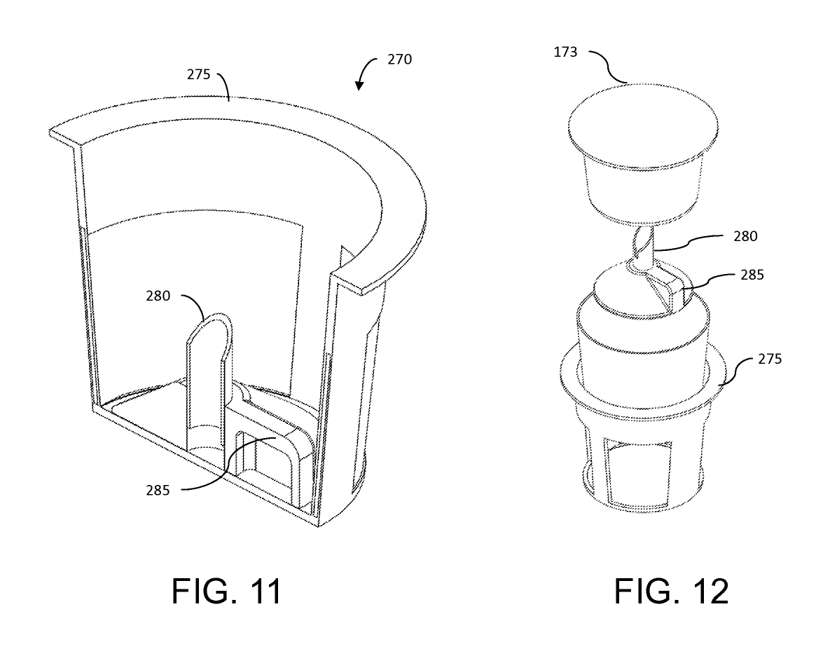

The single serve brewing system 100 also includes a pod retaining assembly 160 which has a housing 165 adapted to fit in the basket of a conventional drip coffee maker (shown in FIGS. 11 and 12). The pod retaining assembly 160 includes a pod support member 170 adapted to support a brewing material pod 173. The pod retaining assembly 160 also includes a second piercing member 175. The pod support member 170 and the second piercing member 175 may be attached to the housing 165 or may be integrally formed with the housing 165. The pod retaining assembly 160 also includes an opening 180 through the second piercing member 175 and the housing 165. The opening 180 allows the brewed material to flow out of the single serve brewing system 100 and into a container (not shown). The pod retaining assembly 160 is provided with a dilution opening 185 passing through the housing 165. The dilution opening 185 allows water to bypass the brewing material pod 173 and flow into the container. The pod retaining assembly 160 may be provided with a cylindrical support member 190. The pod retaining assembly 160 may also be provided with a hinge pivot 193 adapted to engage the hinge cylinder 155, thereby allowing the water reservoir assembly 105 to be pivotally coupled to the pod retaining assembly 160. The pod retaining assembly 160 may be provided with an outwardly disposed projection 195 that engages the inwardly projecting locking protrusion 115 of the water reservoir assembly 105 to secure or lock the pod retaining assembly 160 to the water reservoir assembly 105. Other locking systems or mechanisms are contemplated as would be apparent to one of ordinary skill in the art.

The single serve brewing system 100 may also include a strength adjustment assembly 200. In one embodiment the strength adjustment assembly 200 may include a hollow threaded tube 205 having a protruding tip 210 adapted to be inserted through the water bypass opening 145. The hollow threaded tube 205 may be provided with a flange 215 to prevent the protruding tip 210 from extending past a predetermined position. A brew control knob 216 may engage the hollow threaded tube 205 so that when the knob is turned, the hollow threaded tube 205 is displaced vertically. The hollow threaded tube 205 has a first end (protruding tip 210 adapted to extend through the water bypass opening 145 and a second end coupled to the dilution opening 185 to bypass the interior space of the pod retaining assembly 160.

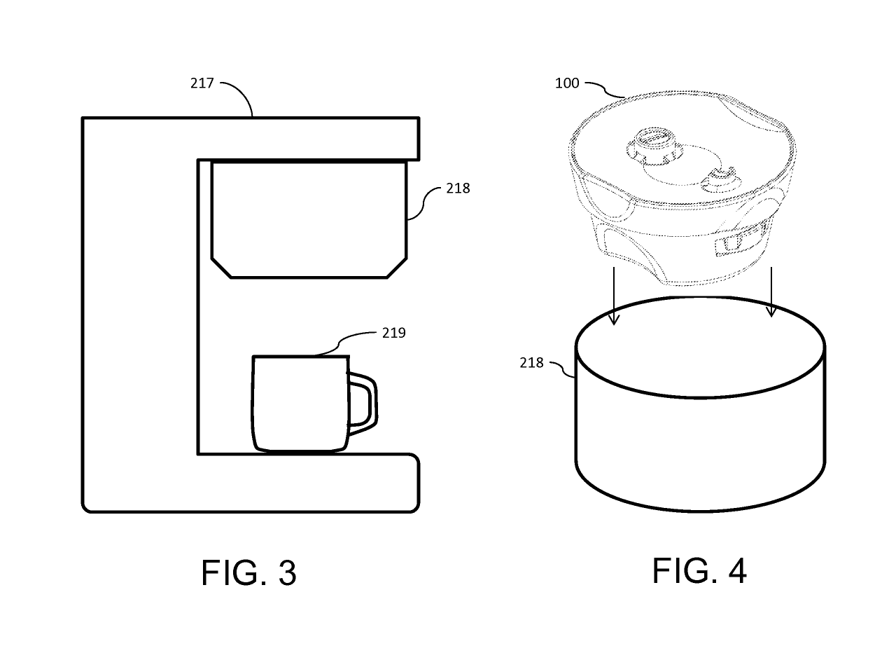

The operation of the single serve brewing system 100 begins with the opening of the single serve brewing system 100 by unlocking the pod retaining assembly 160 from the water reservoir assembly 105 and pivoting the water reservoir assembly 105. A brewing material pod 173 is inserted into the pod support member 170. The single serve brewing system 100 is then closed by pivoting the water reservoir assembly 105 and locking the water reservoir assembly 105 and the pod retaining assembly 160. Upon closing of the single serve brewing system 100, the first piercing member 120 pierces the top of the brewing material pod 173; and the second piercing member 175 pierces the bottom of the brewing material pod 173. As shown in FIGS. 3 and 4, the single serve brewing system 100 is then inserted into the brewing basket 218 of a drip brew device 217. The drip brew device 217 is filled with a predetermined volume of water for such as for example enough water for a single serve of the brewed beverage. The water is heated in the drip brew device 217 and the hot water is transported to and fills the water reservoir assembly 105. A portion of the hot water flows through the brew port 135 and into the brewing material pod 173 where it mixes with the brewing material to create a brewed beverage. A portion of the water flows through the water bypass opening 145 and the dilution opening 185 and into the container 219. The volume of water that flows through the water bypass opening 145 is controlled by adjusting the distance that the protruding tip 210 extends past the water bypass opening 145. The distance that the protruding tip 210 extends past the water bypass opening 145 is controlled by rotating the brew control knob 216 which vertically displaces the hollow threaded tube 205. The brewed beverage flows from the opening 180 into the brewed beverage container 219. Water flows from the protruding tip 210 through the hollow tube and out of the dilution opening 185 into the beverage container 219. After the beverage is brewed, the single serve brewing system 100 is removed from the brewing basket 217. The single serve brewing system 100 is opened, and the brewing material pod is discarded.

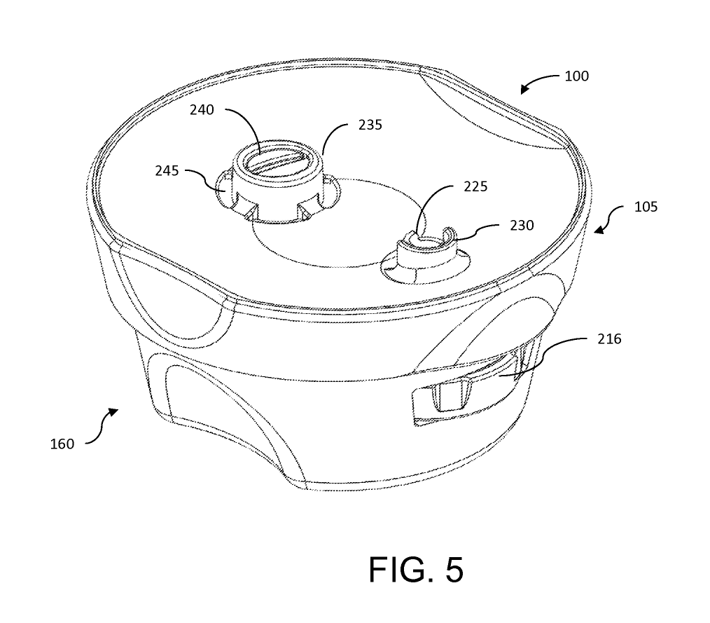

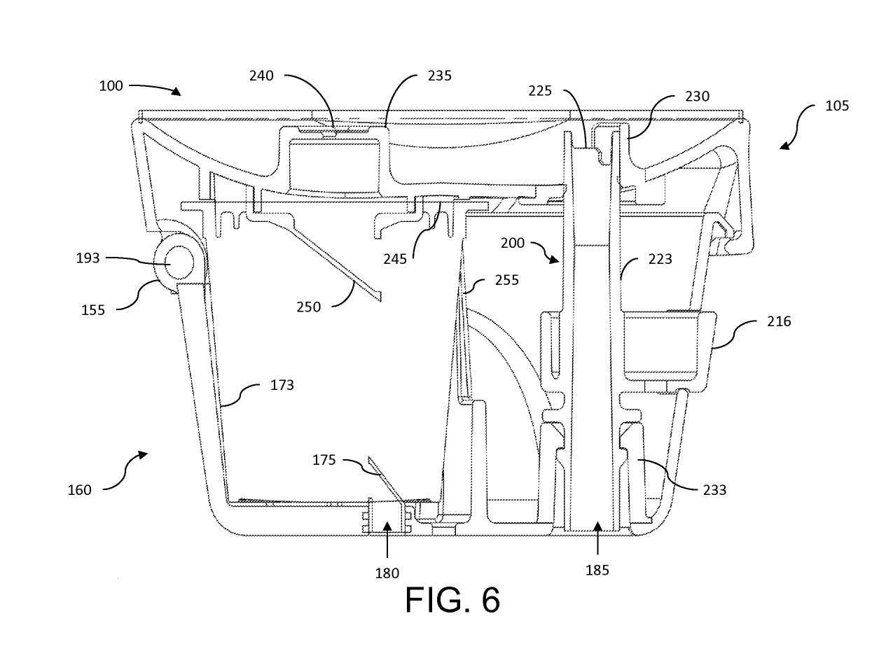

Illustrated in FIGS. 5 and 6 is an alternate embodiment of a single serve brewing system 100. In this embodiment, the strength adjustment assembly 200 includes a hollow tube 223 with a stepped tip 225. The stepped tip 225 is disposed through a semi cylindrical projection 230 which may be attached or formed on the water reservoir assembly 105. The pod retaining assembly 160 may be provided with a tube retaining member 233 that holds the hollow tube 223 in place while allowing for the rotation of the hollow tube 223 when the brew control knob 216 is rotated. In one embodiment, the brew control knob 216 is integrally formed with the hollow tube 223. In one embodiment, the water reservoir assembly 105 may be provided with a tube 235 that has an opening at the top that is above the maximum water level of the stepped tip 225 of the strength adjustment assembly 200. So when grounds float up in to the tube 235, the grounds cannot go out the top since the water level will never proceed above the top of the tube 2223. Water will always go through the hollow tube 223 before it can spill over the top of the hollow tube 223. Basically, it's a trap for grounds to escape out, while at the same time, allowing water to come in. In an alternate embodiment a screen 240 may be disposed in the tube 235. However, a screen limits the flow of water, increasing the brew time (because the screen mesh must be smaller than a coffee ground, which slows the flow of water). The water reservoir assembly 105 may be provided with openings 245 to allow hot water to flow to the brewing material pod 173. An alternate piercing member 250 is also provided. In this embodiment the brewing material pod 173 is held in place by alternate support member 255.

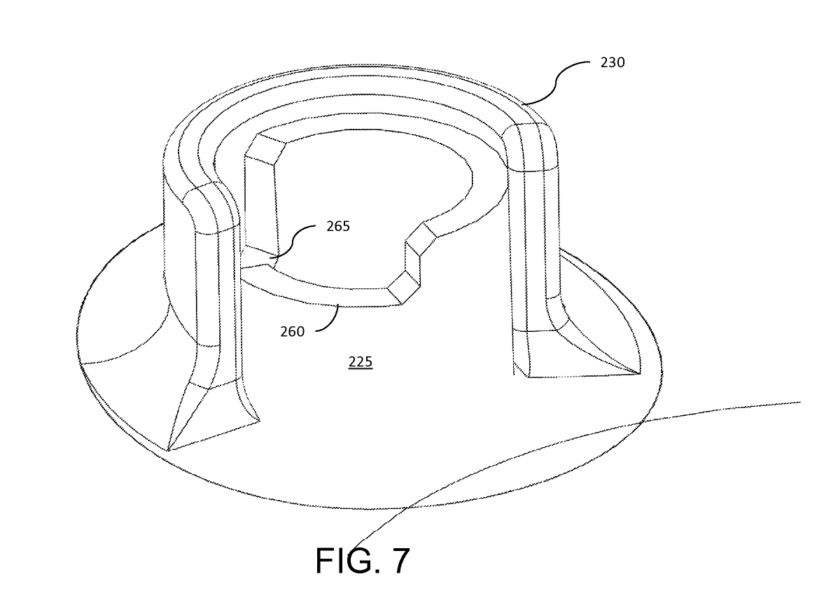

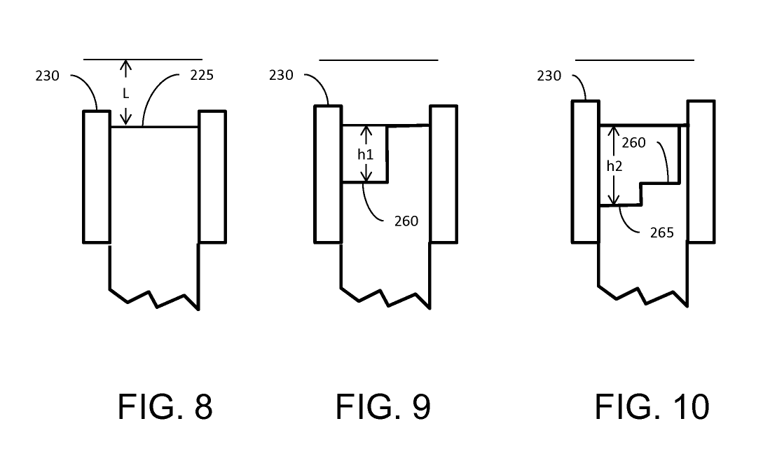

FIG. 7 illustrates the top of an embodiment of a strength adjustment assembly 200. The stepped tip 225 is provided with a first cutout 260 and a second cutout 265. As shown in FIGS. 8, 9, and 10, the first cutout 260 has a height hl and the second cutout 265 has a height h2 which is greater than h1. Depending on the orientation of the stepped tip 225, the strength adjustment assembly 200 may be set in one of a multiple of positions relative to the initial surface level of the water (a distance L from the top of the stepped tip 225) in the water reservoir assembly 105. When the stepped tip 225 is in the closed position (FIG. 8), a first predetermined volume of water will flow into the hollow tube 223 until the surface of the water reaches the top of the stepped tip 225 until the water level has been reduced a distance L. When the stepped tip 225 is in the first open position (FIG. 9) a second predetermined volume of water will flow into the hollow tube 223 until the surface level of the water reaches the bottom of the first cutout 260 (a distance L+h1). When the stepped tip 225 is in the second open position (FIG. 10), a third predetermined volume of water will flow into the hollow tube 223 until the surface of the water reaches the bottom of the second cutout 265 (a distance L+h2).

Brewing material pods 173 come in different sizes. Illustrated in FIGS. 11 and 12 is an adapter assembly 270 that accommodates a smaller brewing material pod 173 for use with the single serve brewing system 100. The adapter assembly includes an adapter housing 275, an adapter piercing member 280, and a pod offset member 285. The brewing material pod 173 is disposed inside the adapter housing 275, and the adapter assembly 270 is disposed inside of the single serve brewing system 100. When the single serve brewing system 100 is closed, the first piercing member 120 of the water reservoir assembly 105 will pierce the brewing material pod 173 and force the brewing material pod 173 into the adapter piercing member 280. The pod offset member 285 supports the brewing material pod 173 and together with the first piercing member 120, secures the smaller brewing material pod 173 to the adapter assembly 270.

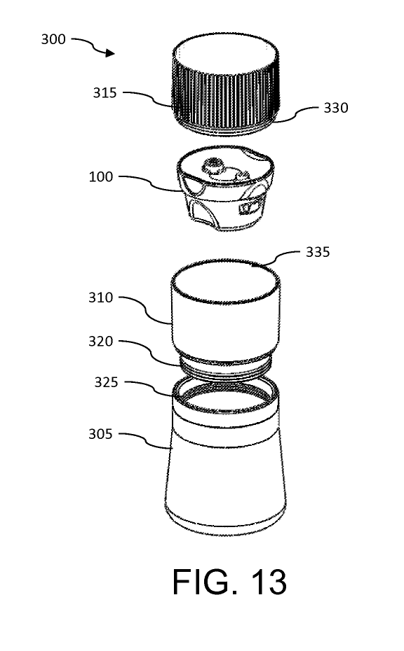

Illustrated in FIG. 13 is a pour over brewer assembly 300. The pour over brewer assembly 300 includes a cup component 305, a holder component 310, a single serve brewing system 100, and a top lid 315. The top lid 315 is provided with a recess having a volume equal to one or 2 cups of coffee. The holder component 310 is adapted to hold the single serve brewing system 100 and may be provided with a threaded end portion 320 adapted to engage a threaded portion 325 of the cup component 305. In one embodiment, the single serve brewing system 100 may be integrally formed into the holder component 310 to minimize parts and costs. The top lid 315 may be provided with a threaded end portion 330 adapted to engage a threaded portion 335 of the holder component 310. It is contemplated that other methods of connecting the top lid 315 to the holder component 310 may be used, such as for example a press fit, or a hinge assembly. The top lid 315 is provided with a small hole designed to drip water down onto the single serve brewing system 100 at a slow, controlled rate similar in speed to an electric drip coffee maker. The hot water percolates through the single serve brewing system 100 and into the cup component 305 as brewed coffee. In another embodiment, an electric heater may be provided on the top lid 315 to heat the water to be used for brewing purposes.

Where the definition of terms departs from the commonly used meaning of the term, applicant intends to utilize the definitions provided below, unless specifically indicated.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. An apparatus comprising:
a water reservoir assembly comprising:
a concave member defining a predetermined volume;
a first piercing member disposed on the concave member;
a brew port formed on the concave member;
a water bypass opening formed on the concave member; and
an opening permitting outflow, which may be secured by a stopper;
a pod retaining assembly pivotally coupled to the water reservoir assembly, the pod retaining assembly comprising:
a housing defining an interior space;
a pod support member;
a second piercing member;
a brewed beverage opening; and
a dilution opening; and
a strength adjustment assembly comprising:
a hollow tube disposed in the housing and having a first end adapted to extend through the water bypass opening and a second end coupled to the dilution opening to bypass the interior space; and
a knob coupled to the hollow tube adapted to displace the hollow tube.

2. The apparatus of claim 1 further comprising a locking system for locking the water reservoir assembly to the pod retaining assembly.

3. The apparatus of claim 1 further comprising a screen disposed on the brew port.

4. The apparatus of claim 1 wherein the hollow tube is displaced vertically.

5. The apparatus of claim 1 wherein the hollow tube is displaced by rotating about an axis.

6. The apparatus of claim 1 wherein the piercing member is integrally formed on the water reservoir assembly.

7. The apparatus of claim 1 wherein the hollow tube is an externally threaded tube.

8. The apparatus of claim 7 wherein the knob is a threaded wheel adapted to engage the threaded tube.

9. The apparatus of claim 1 wherein the concave member defines a concavity of predetermined depth, and the end of the hollow tube extends through a portion of the predetermined depth.

10. The apparatus of claim 1 wherein the first piercing member has an opening aligned with the brew port.

11. A beverage pod receptacle comprising:
a concave member having a brew port and a water bypass opening;
a housing pivotally coupled to the concave member;
a pod support member formed on the housing;
a first piercing member disposed on the concave member;
a second piercing member disposed on the housing below the pod support member;
a hollow tube disposed in the housing, the tube adapted to extend through the water bypass opening; and
means for displacing the hollow tube.

12. The beverage pod receptacle of claim 11 further comprising means for locking the concave member to the housing.

13. The beverage pod receptacle of claim 11 further comprising a screen disposed on the coffee brew port.

14. The beverage pod receptacle of claim 11 further comprising a seal disposed on the water bypass opening.

15. The beverage pod receptacle of claim 11 wherein the hollow tube is an externally threaded tube and the means for displacing the tube comprises a knob adapted to engage the externally threaded tube.

16. An apparatus for brewing a single serve of coffee into a container in a drip coffee maker comprising:
a reservoir for hot water from the drip coffee maker;
means for holding a pod containing coffee grounds;
means for piercing the top of the pod;
means for piercing the bottom of the pod;
means for flowing a portion of the hot water through the pod to make brewed coffee;
means for flowing a portion of the water directly into the container to adjust the strength of the brewed coffee; and
means for controlling the portion of the water flowing into the container.

17. The apparatus of claim 16 wherein the reservoir comprises a concave member defining a predetermined volume which will be of sufficient size to permit the brewing of at least a single serving of coffee.

18. The apparatus of claim 16 wherein the means for holding a pod comprises:
a housing;
a pod support member;
a brewed coffee opening; and
a dilution opening; and
wherein the means for piercing the bottom of the pod comprises a second piercing member disposed on the housing.

19. The apparatus of claim 16 wherein the means for flowing a portion of the water directly into the container comprises:
a hollow tube disposed in the housing and having an end adapted to extend through the water bypass opening;
a knob coupled to the hollow tube adapted to displace the hollow tube; and
a stopper device to control the flow to the container, or for preventing unwanted discharge when not in use.

20. The apparatus of claim 18 wherein the means for flowing a portion of the water directly into the container is disposed in the housing.
